(19) United States
(12) Patent Application Publication
(10) Pub. No.: US 2012/0326448 A1
(43) Pub. Date: Dec. 27, 2012

(54) RAIL BARREL DIRECT ENERGY TRANSFEROR PIEZOELECTRICITY

(76) Inventor: VARNELL CASTOR, Chelsea, MA (US)

(21) Appl. No.: 13/494,154

(22) Filed: Jun. 12, 2012

Related U.S. Application Data
(60) Provisional application No. 61/501,233, filed on Jun. 26, 2011.

(51) Int. Cl. H02K 7/18; H02N 2/18; F03G 7/10

(52) U.S. Cl. 290/1 A; 310/339; 74/DIG. 9

(57) ABSTRACT

The rail barrel direct energy transferor is a modified rail barrel within which a flywheel consisting of two propellers rotate and traverse back and forth in order to transfer rotational energy to generators provided at distal ends of said rail barrel. The interior of the rail barrel is outfitted with a threaded rod upon which two propellers rotate about and traverse back and forth along. The propellers are adjacent one another and include longitudinal members that extend away from one another. The longitudinal members engage the generators when traversed down the threaded rod in order to transfer the rotational energy. The distal ends include spring pistons that are pushed against when the propellers reach the respective end of the rail barrel. The spring pistons being supplied compressed air from a source, and which pushes the propellers of the flywheel in order to continue the traversing motion.

### CROSS REFERENCES TO RELATED APPLICATIONS

This non-provisional utility patent application claims priority to provisional patent application 61/501,233, which was filed on Jun. 26, 2011.

### STATEMENT REGARDING FEDERALLY SPONSORED RESEARCH Not Applicable

### REFERENCE TO APPENDIX

Not Applicable

### BACKGROUND OF THE INVENTION

A. Field of the Invention

The present invention relates to the field of energy production, conservation, and transference; more specifically, rail barrel that inputs kinetic and potential energy into a flywheel and applicable generators for subsequent release.

B. Discussion of the Prior Art

As will be discussed immediately below, no prior art discloses an electricity production system comprising a rail barrel that includes a generator at distal ends, and within which a threaded rod is extended; wherein a flywheel made of two propellers are provided adjacent one another, and travel collectively up and down the threaded rod; wherein the propellers each include longitudinal members that extend away traveling back and forth along the threaded rod; wherein the longitudinal members engage the generators in order to transfer rotational energy from the rotation of the propeller to the respective generator; wherein spring pistons are provided adjacent both generators and enable the propellers to be pushed away when engaged against the respective generator such that the propellers traverse back and forth along threaded rod inside of the rail barrel, and while rotating the propellers along the course of travel of said rail barrel; wherein an outside compressed air source is imparted through the spring pistons in order to push the flywheel back and forth, and keep the process continuing; wherein piezoelectric discs are positioned between the distal ends of the threaded rod and the respective generator such that upon impact with the flywheel, said piezoelectric disc shall generate electricity, which is transferred to said capacitor.

The Patel Patent Application Publication (U.S. Pub. No. 2009/0302808) discloses a flywheel that relies upon magnetically-charged components to rotate, and produce electricity. However, the flywheel does not traverse back and forth along a threaded rod located inside of a rail barrel, and which is pushed back and forth via spring-pistons that use compressed air in concert with the spring to continue the traversing motion back and forth inside of the rail barrel.

The Tianchon Patent Application Publication (U.S. Pub. No. 2010/0276943) discloses an electricity generating plant employing perpetual power generation inclusive of a flywheel. However, the flywheel does not traverse back and forth along a rail barrel, and rely upon spring-pistons to continue said motion.

The Tokita Patent (U.S. Pat. No. 6,365,981) discloses a power generation system with flywheel apparatus. However, the flywheel apparatus does not traverse back and forth along a rail barrel in order to perpetuate the rotational movement of propellers, which are transferred to generators located at distal ends of said rail barrel.

The Gabrys Patent (U.S. Pat. No. 6,624,542) discloses a flywheel power source with passive generator cooling, which is supported by a bearing system for rotation inside of an evacuated container, and which further includes a brushless motor and generator coupled to said flywheel. However, the configuration of componentry does not include or involve transverse motion of a flywheel along a rail barrel in order to perpetuate rotational movement from said flywheel to generators provided at distal ends.

While the above-described devices fulfill their respective and particular objects and requirements, they do not describe an electricity production system comprising a rail barrel that includes a generator at distal ends, and within which a threaded rod is extended; wherein a flywheel made of two propellers are provided adjacent one another, and travel collectively up and down the threaded rod; wherein the propellers each include longitudinal members that extend away from one another, and which engage with the generators when traveling, back and forth along the threaded rod; wherein the longitudinal members engage the generators in order to transfer rotational energy from the rotation of the propeller to the respective generator; wherein spring pistons are provided adjacent both generators and enable the propellers to be pushed away when engaged against the respective generator such that the propellers traverse back and forth along threaded rod inside of the rail barrel, and while rotating the propellers along the course of travel of said rail barrel; wherein an outside compressed air source is imparted through the spring pistons in order to push the flywheel back and forth, and keep the process continuing; wherein piezoelectric discs are positioned between the distal ends of the threaded rod and the respective generator such that upon impact with the flywheel, said piezoelectric disc shall generate electricity, which is transferred to said capacitor. In this regard, the rail barrel departs from the conventional concepts and designs of the prior art.

### SUMMARY OF THE INVENTION

The rail barrel direct energy transferor piezoelectricity is an electricity production system including a modified rail barrel within which a flywheel consisting of two propellers rotate and traverse back and forth in order to transfer rotational energy to generators provided at distal ends of said rail barrel. The interior of the rail barrel is outfitted with a threaded rod upon which two propellers rotate about and traverse back and forth along. The propellers are adjacent one another and include longitudinal members that extend away from one another. The longitudinal members engage the generators when traversed down the threaded rod in order to transfer the rotational energy. The distal ends include spring pistons that are pushed against when the propellers reach the respective end of the rail barrel. The spring pistons being supplied compressed air from a source, and which pushes the propellers of the flywheel in order to continue the traversing motion back and forth within the rail barrel and along the threaded rod.

An object of the invention is to provide a modified rail barrel that includes generators at distal ends and which are sequentially transferred rotational energy from a flywheel comprised of two propellers that are wind driven from inside of the rail barrel.

Another object of the invention is to provide a threaded rod that enables the flywheel to traverse back and forth inside of the rail barrel in order to transfer rotational energy to generators positioned at distal ends.

A further object of the invention is to provide spring pistons adjacent each distal end, which when compressed shall recoil and push the spinning propellers of the flywheel backwardly in order to continue traversing back and forth inside of the rail barrel.

An even further object of the invention is to supply a compressed air source to the spring pistons in order to aid along with the springs in pushing the flywheel backwards when so engaged, which shall thereby continue the traverse motion, and impart newly added rotational inertia to the flywheel as the flywheel progresses down the length of the rail barrel.

A further object of the invention is to provide a magnetic induction generator adjacent to each generator, and which includes a magnet that when travels back and forth within an induction coil produces an auxiliary means Of power generation in conjunction with the rotation of the respective generator.

Another object of the invention is to include with the flywheel longitudinal members on each propeller that extend away from the respective side of the flywheel, and which engages the generator in order to transfer the rotational energy thereto.

A further object of the invention is to provide a storage unit capacitor that stores electricity therein, and which is transferred outside of the invention in a single electrical pulse, and which is in electrical communication with an electrical grid or to a compressed air source in order to generate compressed air for use with the spring pistons.

A further object of the invention is to include piezoelectricity as an additional means of electricity production.

An even further object of the invention is to provide piezoelectric discs mounted on distal ends of the threaded rod, and which interact with the flywheel to undergo a compressive force thereby generating electricity, which is transferred to said first capacitor.

These together with additional objects, features and advantages of the rail barrel will be readily apparent to those of ordinary skill in the art upon reading the following detailed description of presently preferred, but nonetheless illustrative, embodiments of the rail barrel when taken in conjunction with the accompanying drawings.

In this respect, before explaining the current embodiments of the rail barrel in detail, it is to be understood that the rail barrel is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the rail barrel.

It is therefore important that the claims be regarded as including such equivalent construction insofar as they do not depart from the spirit and scope of the rail barrel. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a side view of the exterior of the rail barrel in use, and in wired communication with a control house and applicable electrical grid;

FIG. 2 illustrates a cross-sectional view of the-rail barrel along line 2-2 in FIG. 1, and detailing the configuration of the applicable componentry therein;

FIG. 3 illustrates a top view of the interior of the flywheel;

FIG. 4 illustrates a perspective view of the two propellers each with longitudinal members provided thereon;

FIG. 5 illustrates a distal end of the rail barrel with detail as to the construction of one of the magnetic induction generators; and

FIG. 6 illustrates an end view of a distal end inside of the rail barrel and depicting the configuration and arrangement of the generator, the spring pistons, and the magnetic induction generators therein.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

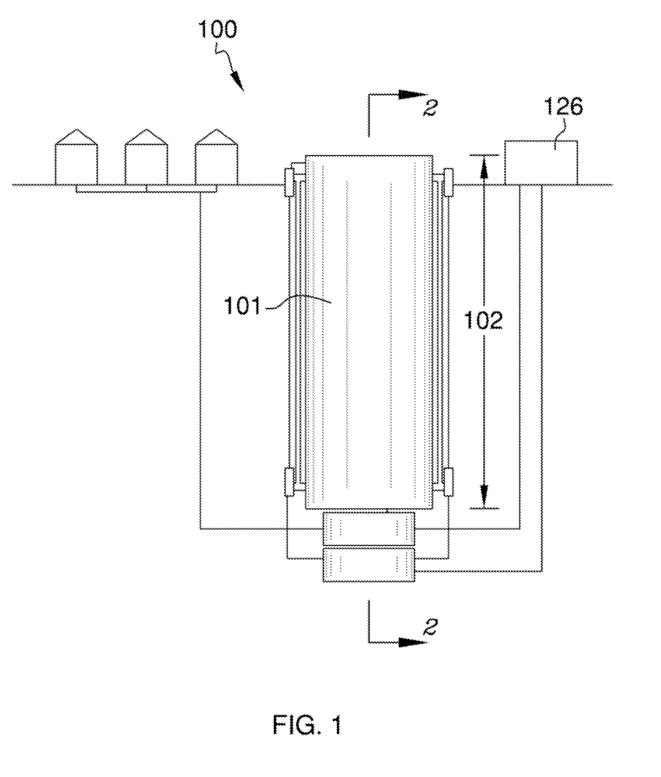

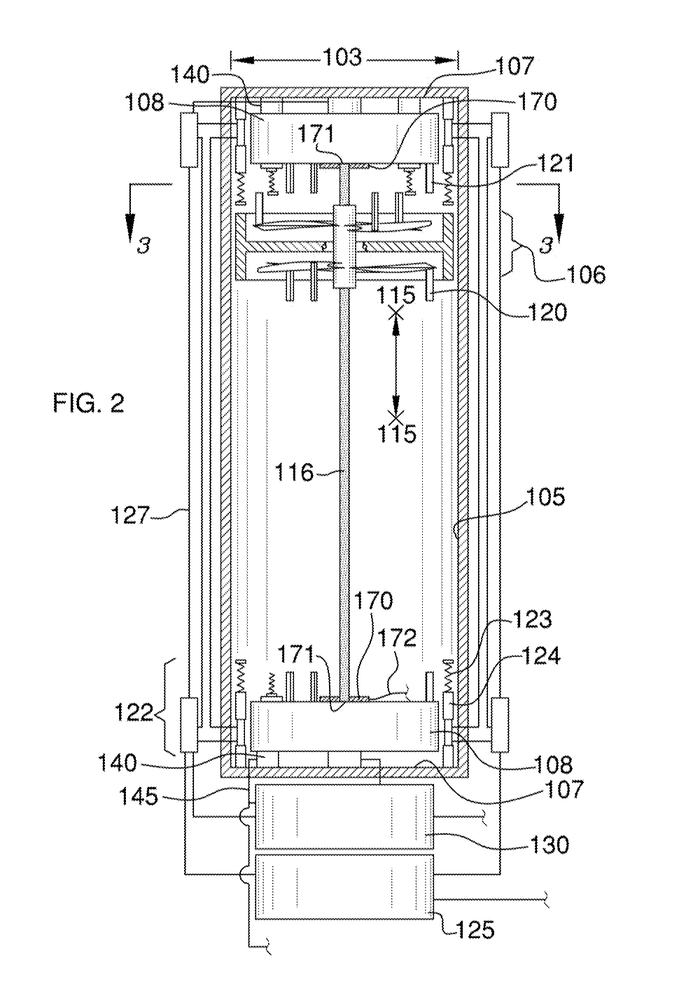

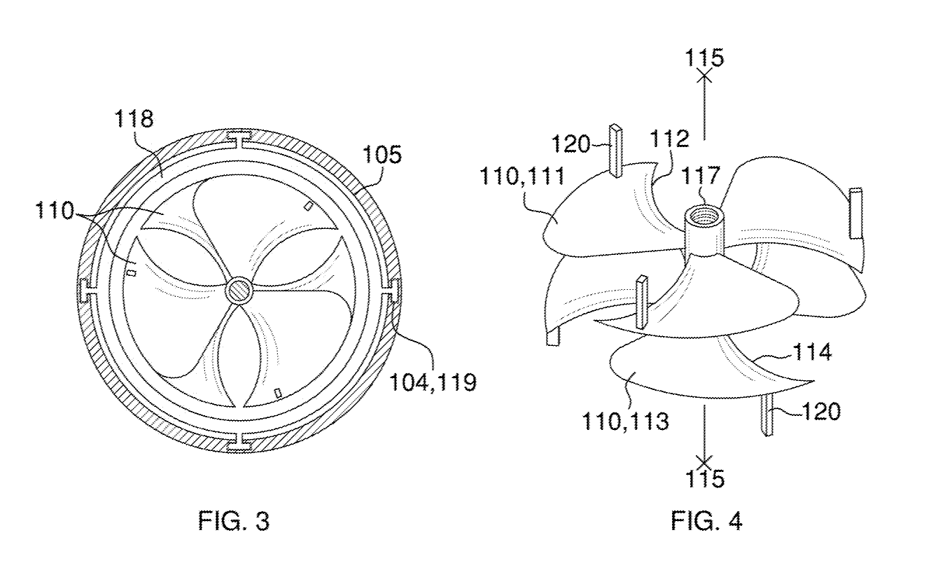

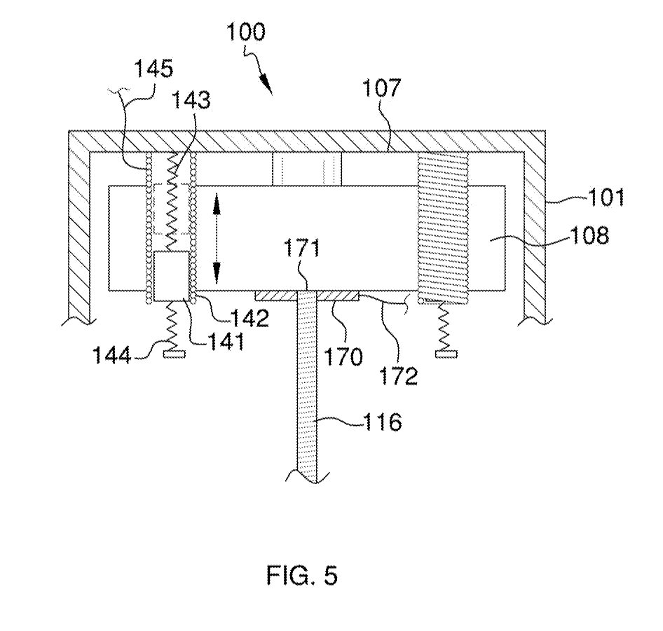

Detailed reference will now be made to the preferred embodiment of the present invention, examples of which are illustrated in FIGS. 1-6. A rail barrel direct energy transferor piezoelectricity 100 (hereinafter invention) includes a rail barrel 101 of an undefined length 102 and undefined inner diameter 103. That being said, the rail barrel 101 is of hollowed construction and includes grooved tracks 104 extending lengthwise along an inner surface 105 with which a flywheel 106 engages and traverses back and forth between distal ends 107.

The rail barrel 101 includes generators 108 at the distal ends 107, and draw rotational energy from the flywheel 106 When in contact therewith. It shall be noted that the invention 100 is designed in such a away that the flywheel 106 continuously traverses back and forth between the distal ends 107 in order to transfer rotational energy to the generators 108 for electrical production as well as to generate, new rotational inertia into the flywheel 106 when in between the distal ends 107. That being said, the flywheel 106 loses a portion of the rotational inertia stored therein when communicated to the generator 108 so contacted, and upon moving away from said gnerator 108 and moving towards an opposing distal end, said flywheel 106 is imparted new rotational inertia in order to restore the level of rotational inertia therein for transference to the generator 108 at the opposing distal end 106, etc.

The flywheel 106 is constructed of two propellers 110 that are oriented backwards with one another such that a first propeller 111 has a leading edge 112 opposite of a second propeller's 113 leading edge 114. The propellers 110 both rotate harmoniously together, and along a vertical axis 115 inside of the rail barrel 101. The rail barrel 101 includes a threaded rod 116 that extends between the two generators 108, and guides the flywheel 106 back and forth there between. The flywheel 106 include's a threaded sleeve 117 that is communicated between the two propellers 110. The threaded sleeve 117 is threadably engaged upon the threaded rod 116 such that as the flywheel 106 goes from one distal end 107 to another. distal end 107, the propellers and threaded sleeve 117 rotate with respect to the threaded rod 116.

The flywheel 106 includes a housing 118 that is able to freely rotate with respect to the propellers 110, and which includes armatures 119 that engage the grooved tracks 104 inside of the rail barrel 101. The armatures 119 and the grooved tracks 104 insure laminar movement of the flywheel 106 back and forth inside of the rail barrel 101.

The propellers 110 each include longitudinal members 120 that extend away from the respective propeller 110, and are responsible for engagement and transference of rotational inertia from the flywheel 106 to the generator 108 when in contact. That being said the generators 108 each include generator longitudinal members 121, which extend away from the respective distal end 107, and are engaged when the flywheel 106 is in contact, and at which point the longitudinal members 120 shall rotate the generator longitudinal members 121. The rotation of the generator longitudinal members 121 results in the generator 108 producing electricity, which is transferred to first capacitor 130 located outside of the rail barrel 101. Both generators 108 produce electricity, which is transferred to the first capacitor 130.

Spring pistons 122 are located at each distal end 107, and are responsible for propelling the flywheel 106 back and forth along the inside of the rail barrel 101. The spring pistons 122 each include a spring 123 coupled with a piston 124. The piston 124 is connected to an air chamber 125, which Supplies compressed air to all of the pistons 124 via compressed air hoses 127. The air chamber 125 is supplied compressed air from a compressed air source 126.

Located elsewhere and adjacent to each distal end 107 of the rail barrel 101 are magnetic induction generators 140. The magnetic induction generators 140 produce electricity upon movement of a magnet 141 back and forth inside of an, induction coil 142. Each magnet 141 includes a first spring 143 and a second spring 144. The first spring 143 is located on a side of the magnet 141 opposite of the second spring 144. The first spring 143 connects the magnet 141 to the distal end 107 of the rail barrel 101 such that the magnet 141 can travel back and forth within the induction coil 142. The second spring 144 extends away from the adjacent distal end 107 of the rail barrel 101, and is responsible for hitting against the flywheel 106 when engaging against the respective generator 108. It shall be noted that the magnet 141 produces electricity to the induction coil 142 upon traversing back and forth therein.

The movement of the magnet 141 back and forth within the induction coil 142 is accomplished by virtue of the first spring 143 and the second spring 144 in communication between the flywheel 106 and the distal end 107 of the rail barrel 101. It shall be noted that as the flywheel 106 traverses back and forth inside of the rail barrel 101, a noticeable amount of vibration is generated to the rail barrel 101. The vibration associated with traverse motion of the flywheel 106 inside of the rail barrel 101 is capable of causing the first spring 143 to extend and retract, which causes the magnet 141 to move back and forth inside of the induction coil 142 thereby producing electricity.

Electricity produced via the magnetic induction generators 140 can be transferred via an induction generator wire 145 to the first capacitor 130 or to power the compressed air source 126. That being said, the compressed air source 126 is commonly an air compressor that requires electricity in order to run a motor to compress air, which is transferred via the applicable compressed air hose 127 to the air chamber 125, which then transfers the compressed air back to the pistons 124 of the spring pistons 122.

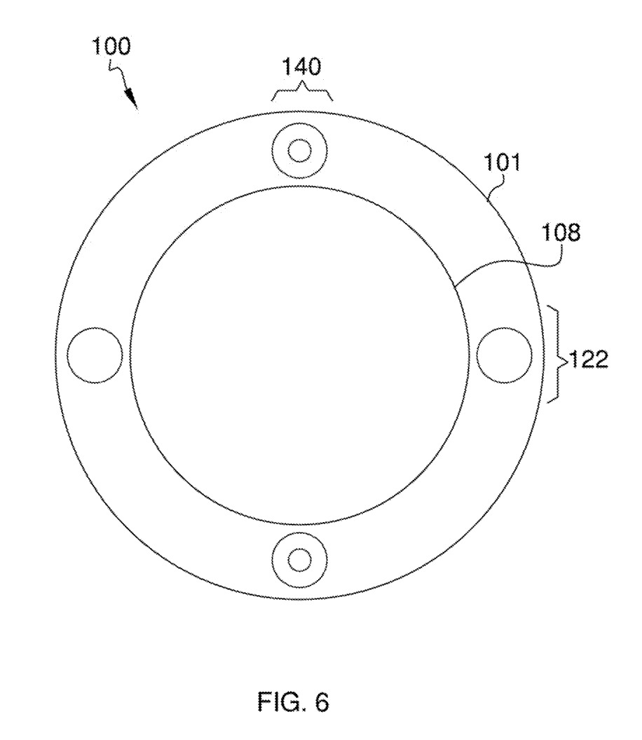

It shall be noted that each distal end 107 may include at least one spring piston 122 and at least one magnetic induction generator 140. In referring to FIG. 6, the distal end 107 may place the, generator 106 about the middle, and around which are placed the spring-pistons 122 and the magnetic induction generators 140.

The invention 100 may include piezoelectric-producing means into the rail barrel 101, and which produce electricity in conjunction with the movement of the flywheel 106. Moreover, piezoelectric discs 170 may be mounted on threaded distal ends 171 of the threaded rod. 116. It shall be noted that the threaded distal ends 171 are defined as the end of the threaded rod 116 that would otherwise engage against the respective generator 108. The piezoelectric discs 170 would undergo a compressive force when the flywheel 106 has traveled thereto Via the threaded rod 116, and upon undergoing compressive force, the piezoelectric discs 170 shall generate electricity that is transmitted via a piezo-wire 172. The piezo-wire 172 would transmit the produced electricity to the first capacitor 130.

With respect to the above description, it is to be realized that the optimum dimensional relationship for the various components of the invention 100, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the invention 100.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A direct energy transference rail barrel comprising:
a rail barrel within which a flywheel traverses back and forth between distal ends in order to transfer rotational inertia to generators located at said distal end;
wherein the flywheel is rotatable engaged along a threaded rod that spans between said distal ends such that when the flywheel is traversing down a length of said rail barrel rotational inertia is added to said flywheel, which is consequentially removed when engaged against a respective generator of the respective distal end;
wherein the distal ends including spring pistons that when engaged with said flywheel propel said flywheel backwards to an opposing distal end;
wherein the spring pistons are provided compressed air to push the flywheel when so engaged;
wherein said compressed air is supplied from a compressed air source;
wherein the distal ends include magnetic induction coils that produce electricity when engaged with the flywheel, and said electricity being transferred either to a first capacitor or to power said compressed air source;
wherein said generators produce electricity that is transferred to said first capacitor.

2. The rail barrel as described in claim 1 wherein the rail barrel is of an undefined length having an undefined inner diameter, and including grooved tracks extending lengthwise along an inner surface with which said flywheel engages and traverses back and forth between distal ends.

3. The rail barrel as described in claim 2 wherein the flywheel is comprised of two propellers that oriented backwards with one another such that a first propeller has a leading edge opposite of a second propeller's leading edge; wherein the propellers both rotate harmoniously together, and along a vertical axis inside of the rail barrel; wherein the flywheel includes a threaded sleeve that is communicated between the two propellers; wherein the threaded sleeve is threadably engaged upon the threaded rod such that as the flywheel goes from one distal end to another distal end, the propellers and threaded sleeve rotate with respect to the threaded rod.

4. The rail barrel as described in claim 3 wherein the flywheel includes a housing that is able to freely rotate with respect to the propellers, and which includes armatures that engage the grooved tracks inside of the rail barrel; wherein the armatures and the grooved tracks enable laminar traverse movement of the flywheel back and forth between the distal ends of the rail barrel.

5. The rail barrel as described in claim 4 wherein the propellers each include longitudinal members that extend away from the respective propeller, and are responsible for engagement and transference of rotational inertia from the flywheel to the generator when in contact; wherein said generators each include generator longitudinal members, which extend away from the respective distal end; and are engaged when the flywheel is in contact, and at which point the longitudinal members shall rotate the generator longitudinal members; wherein the rotation of the generator longitudinal members results in the generator producing electricity, which is transferred to first capacitor.

6. The rail barrel as described in claim 1 wherein the spring pistons located at each distal end are responsible for propelling the flywheel back and forth along the inside of the rail barrel; wherein the spring pistons each include a spring coupled with a piston; wherein the piston is connected to an air chamber, which supplies compressed air to all of the pistons via compressed air hoses; wherein the air chamber is supplied compressed air from a compressed air source.

7. The rail barrel as described in claim 1 wherein the magnetic induction generators produce electricity upon movement of a magnet back and forth inside of an induction coil; wherein each magnet includes a first spring and a second spring; wherein the first spring is located on a side of the magnet opposite of the second spring; wherein the first spring connects the magnet to the distal end of the rail barrel such that the magnet can travel back and forth within the induction coil.

8. The rail barrel as described in claim 7 wherein the second spring extends away from the adjacent distal end of the rail barrel, and is responsible for hitting against the flywheel when engaging against the respective generator; wherein the movement of the magnet back and forth within the induction coil is accomplished by virtue of the first spring and the second spring in communication between the flywheel and the distal end of the, rail barrel as well as any vibration associated with movement of the flywheel back and forth within the rail barrel.

9. The rail barrel as described in claim 8 wherein electricity produced via the magnetic induction generators is transferred via an induction generator wire to either the first capacitor or to power the compressed air source directly.

10. A direct energy transference rail barrel comprising:
a rail barrel within which a flywheel traverses back and forth between distal ends in order to transfer rotational inertia to generators located at said distal end;
wherein the flywheel is rotatable engaged along a threaded rod that spans between said distal ends such that when the flywheel is traversing down a length of said rail barrel rotational inertia is added to said flywheel, which is consequentially removed when engaged against a respective generator of the respective distal end;
wherein the distal ends including spring pistons that when engaged with said flywheel propel said flywheel backwards to an opposing distal end;
wherein the spring pistons are provided compressed air to push the flywheel when so engaged;
wherein said compressed air is supplied froth a compressed air source;
wherein the distal ends include magnetic induction coils that produce electricity when engaged with the flywheel, and said electricity being transferred either to a first capacitor or to power said compressed air source;
wherein said generators produce electricity that is transferred to said first capacitor;
wherein the rail barrel is of an undefined length having an undefined inner diameter, and including grooved tracks extending lengthwise along an inner surface with which said flywheel engages and traverses back and forth between distal ends.

11. The rail barrel as described in claim 10 wherein the flywheel is comprised of two propellers that oriented backwards with one another such that a first propeller has a leading edge opposite of a second propeller's leading edge; wherein the propellers both rotate harmoniously together, and along a vertical axis inside of the rail barrel; wherein the flywheel includes a threaded sleeve that is communicated between the two propellers; wherein the threaded sleeve is threadably engaged upon the threaded rod such that as the flywheel goes from one distal end to another distal end, the propellers and threaded sleeve rotate with respect to the threaded rod.

12. The rail barrel as described in claim 11 wherein the flywheel includes a housing that is able to freely rotate with respect to the propellers, and which includes armatures that engage the grooved tracks inside of the rail barrel; wherein the armatures end the grooved tracks enable laminar traverse movement of the flywheel back and forth between the distal ends of the rail barrel.

13. The rail barrel as described in claim 12 wherein the propellers each include longitudinal members that extend away from the respective propeller, and are responsible for engagement and transference of rotational inertia from the flywheel to the generator when in contact; wherein said generators each include generator longitudinal members, which extend away from the respective distal end, and are engaged when the flywheel is in contact, and at which point the longitudinal members shall rotate the generator longitudinal members; wherein the rotation of the generator longitudinal members results in the generator producing electricity, which is transferred to first capacitor.

14. The rail barrel as described in claim 13 wherein the spring pistons located at each distal end are responsible for propelling the flywheel back and forth along the inside of the rail barrel; wherein the spring pistons each include a spring coupled with a piston; wherein the piston is connected to an air chamber, which supplies compressed air to all of the pistons via compressed air hoses; wherein the air chamber is supplied compressed air from a compressed air source.

15. The rail barrel as described in claim 14 wherein the magnetic induction generators produce electricity upon movement of a magnet back and forth inside of an induction coil; wherein each magnet includes a first spring and a second spring; wherein the first spring is located on a side of the magnet opposite of the second spring; wherein the first spring connects the magnet to the distal end of the rail barrel such that the magnet can travel back and forth within the induction coil.

16. The rail barrel as described in claim 15 wherein the second spring extends away from the adjacent distal end of the rail barrel, and is responsible for hitting against the flywheel when engaging against the respective generator;
wherein the movement of the magnet back and forth within the induction coil is accomplished by virtue of the first spring and the second spring in communication between the flywheel and the distal end of the rail barrel as well as any vibration associated with movement of the flywheel back and forth within the rail barrel.

17. The rail barrel as described in claim 16 wherein electricity produced via the magnetic induction generators is transferred via an induction generator wire to either the first capacitor or to power the compressed air source directly.

18. The rail barrel as described in claim 10 wherein piezoelectric discs are mounted on threaded distal ends of the threaded rod and undergo a compressive force when the flywheel has traveled thereto via the threaded rod, and upon which generates electricity that is transmitted via a piezo-wire to the first capacitor.
